(19) United States
(12) Patent Application Publication
(10) Pub. No.: US 2021/0068213 A1
(43) Pub. Date: Mar. 4, 2021

(54) RADIO FREQUENCY AND CONVECTION PROCESSING APPARATUS AND METHOD

(71) Applicant: JOHN BEAN TECHNOLOGIES AB, Helsingborg (SE)

(72) Inventors: Richard Timperio, Catskill, NY (US); Håkan Per Ohlsson, Furulund (SE)

(73) Assignee: JOHN BEAN TECHNOLOGIES AB, Helsingborg (SE)

(21) Appl. No.: 16/651,929

(22) PCT Filed: Oct. 1, 2018
(86) PCT No.: PCT/US2018/053797

§ 371 Date: Mar. 27, 2020

Related U.S. Application Data
(60) Provisional application No. 62/566,166, filed on Sep. 29, 2017.

(51) Int. Cl. H05B 6/64; H05B 6/78; A23L 3/01

(52) U.S. Cl. CPC H05B 6/6479; A23L 3/01; H05B 6/782

(57) ABSTRACT

A system includes a first unit configured to generate and apply radio frequency (RF) energy to a load positioned in the first unit during a first time period, wherein the load is at a first temperature at a start of the first time period and at a second temperature different from the first temperature at an end of the first time period, and a second unit configured to receive the load at the second temperature and to cause heat transfer by convection to the load during a second time period different from the first time period, wherein the load is at a third temperature at an end of the second time period. First and second time periods together is less than or equal to a time period for the load to change from the first temperature to the third temperature from convective processing and without application of the RF energy.

### CROSS-REFERENCE TO RELATED APPLICATIONS

This application claims the benefit of U.S. Provisional Patent Application No. 62/566,166 filed Sep. 29, 2017, the disclosure of which is incorporated herein by reference in its entirety.

### BACKGROUND

The background description provided herein is for the purpose of generally presenting the context of the disclosure. Unless otherwise indicated herein, the materials described in this section are not prior art to the claims in this application and are not admitted to be prior art or suggestions of the prior art, by inclusion in this section.

Materials, such as food products, may be desirous to be processed to a particular end temperature, have particular end product characteristics, processed within a certain time frame, exhibit positive taste, exhibit positive shelf-life, and/or the like. In commercial environments, consistent process reproducibility and/or higher yield may also be design considerations. An example food process may comprise heating or cooking a food product to a particular end temperature. While an overall or average desired end temperature may be achieved, the resulting food product may be lacking in other ways. For example, the temperature in different portions of the resulting food product may differ from each other, which may result in the resulting food product undercooked in some portions and overcooked in other portions. As another example, intermediate changes associated with food products may take longer than desired, thereby extending the overall processing time. This and other characteristics associated with processing of food products (as well as materials, in general) may be desirous to be better controlled and/or achieved.

### SUMMARY

This summary is provided to introduce a selection of concepts in a simplified form that are further described below in the Detailed Description. This summary is not intended to identify key features of the claimed subject matter.

In some embodiments, a method includes positioning a load at a first temperature to electrically couple with a radio frequency (RF) processing system; applying, for a first time period, a RF signal to the load to change a temperature of the load from a first temperature to a second temperature; positioning the load at the second temperature within a convection processing system; and circulating, for a second time period, a heated gaseous medium around the load to change the temperature of the load from the second temperature to a third temperature or to cause the load to undergo a chemical reaction. The first and second time periods together is less than or equal to a time period for the load to change from the first temperature to the third temperature or from the first temperature to undergo the chemical reaction from convective processing and absent application of the RF signal.

In some embodiments, a system includes a first unit configured to generate and apply radio frequency (RF) energy to a load positioned in the first unit during a first time period, wherein the load is at a first temperature at a start of the first time period and at a second temperature different from the first temperature at an end of the first time period; and a second unit configured to receive the load at the second temperature and to cause heat transfer by convection to the load during a second time period different from the first time period, wherein the load is at a third temperature at an end of the second time period. The first and second time periods together is less than or equal to a time period for the load to change from the first temperature to the third temperature from convective processing and without application of the RF energy.

In some embodiments, a system includes a first device that includes first radio frequency (RF) signal generation components and first gaseous medium circulation generation components, the first device configured to simultaneously provide first RF processing and first gaseous medium circulatory processing to a material of interest for a first time period; and a second device that includes second convection generation components, the second device configured to provide second convective processing to the material of interest for a second time period after the first time period. The material of interest changes from a first temperature to a second temperature during the first time period and from the second temperature to a third temperature during the second time period.

In some embodiments, a system includes a first device that includes first radio frequency (RF) signal generation components, the first device configured to provide first RF processing to a material of interest for a first time period; and a second device that includes second RF generation components and second convection generation components, the second device configured to simultaneously provide second RF processing and second convective processing to the material of interest for a second time period after the first time period. The material of interest changes from a first temperature to a second temperature during the first time period and from the second temperature to a third temperature during the second time period.

In some embodiments, a system includes a first unit configured to generate and apply radio frequency (RF) energy and air circulation to a load positioned in the first unit during a first time period, wherein the load is at a first temperature at a start of the first time period and at a second temperature different from the first temperature at an end of the first time period; and a second unit configured to receive the load at the second temperature and to cause heat transfer by convection to the load during a second time period different from the first time period, wherein the load is at a third temperature different from the second temperature at an end of the second time period. At least one of the second or third temperatures is at or near a temperature of a solid-to-liquid phase transition latent zone associated with the load.

### DESCRIPTION OF THE DRAWINGS

The foregoing aspects and many of the attendant advantages of the present disclosure will become more readily appreciated as the same become better understood by reference to the following detailed description, when taken in conjunction with the accompanying drawings.

FIG. 1 depicts a block diagram of an example system in accordance with some embodiments of the present disclosure;

FIG. 2 depicts a block diagram showing an example implementation of the system of FIG. 1 within a multi-stage food processing system in accordance with some embodiments of the present disclosure;

FIG. 3 depicts an example process that may be performed by the system of FIG. 1 to process the material of interest from a start temperature (e.g., the first temperature) to an end temperature (e.g., the third temperature) in accordance with some embodiments of the present disclosure;

FIGS. 4A-4B depict various plot lines associated with dough proofing in accordance with some embodiments of the present disclosure;

FIG. 5 depicts an example alternative system in accordance with alternative embodiments of the present disclosure;

FIGS. 6A-6B depict an example process that may be performed by the system of FIG. 5 to process the material of interest from the first temperature to the third temperature in accordance with alternative embodiments of the present disclosure;

FIG. 7 depicts a top view of a portion of an example combined RF and convection system, device, or module in accordance with some embodiments of the present disclosure;

FIGS. 8A-8B depict an example process that may be performed by the system of FIG. 5 to process the material of interest from the first temperature to the third temperature in accordance with another embodiment of the present disclosure; and

FIGS. 9A-9B depict an example process that may be performed by the system of FIG. 5 to process the material of interest from the first temperature to the third temperature in accordance with still another embodiment of the present disclosure.

### DETAILED DESCRIPTION

Embodiments of a system, apparatus, and method for radio frequency (RF) and convection thermal processing are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

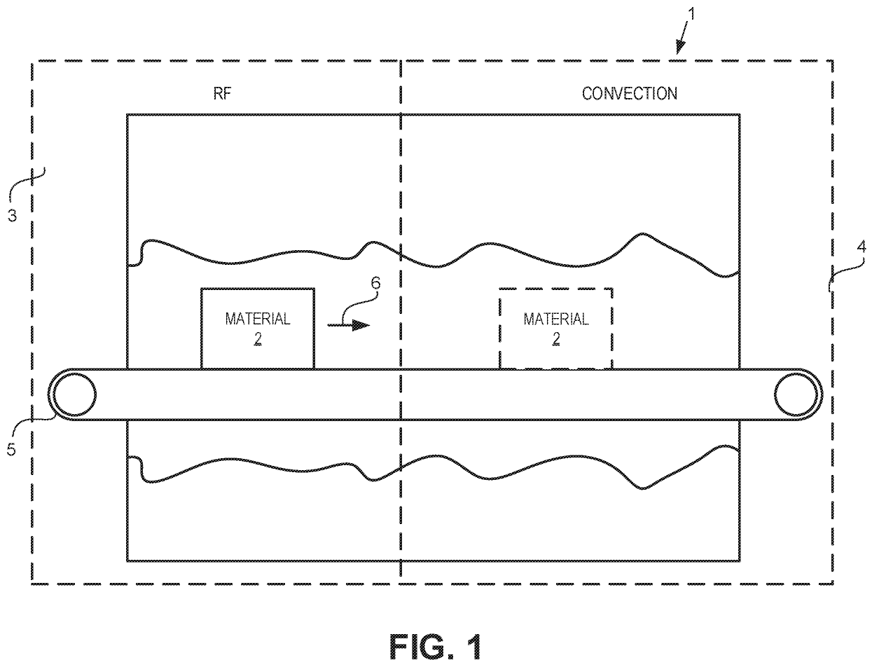

FIG. 1 depicts a block diagram of an example system 1 in accordance with some embodiments of the present disclosure. A partial cut away view of system 1 is shown to depict a material of interest 2 positioned within the system 1 for processing. System 1 may comprise at least two stages or sub-systems—a radio frequency (RF) processing system 3 and a convection processing system 4. RF processing system 3 may also be referred to as a RF system, RF stage, RF based processing system, or the like. Convection processing system 4 may also be referred as a convection system, convection stage, convection based processing system, or the like.

In some embodiments, system 1 may be configured to process the material of interest 2 using more than one processing technique. The material of interest 2, also referred to as a load, material, or product, may be processed by the RF processing system 3 sequentially followed by the convection processing system 4. Material of interest 2 may be located on a transport mechanism 5. Transport mechanism 5 may be configured to move or transport the material of interest 2 in a direction 6 to one or more particular locations within the system 1 (e.g., to align with particular electrodes or gaseous medium circulation pathways) and/or at one or more particular speeds through the system 1 for processing by RF and convection processing systems 3 and 4. Transport mechanism 5 may be configured to operate in continuous motion (e.g., the material of interest 2 continuously moves through system 1 at one or more speeds) and/or in non-continuous motion (e.g., the material of interest 2 moves for a period of time, is stationary for a period of time, moves again for a period of time, and the like). Transport mechanism 5 may comprise, without limitation, conveyor belts, rollers, plates, or the like.

RF processing system 3 may be configured to apply RF energy having particular characteristics to the material of interest 2, to cause the material of interest 2 to change from a first temperature to a second temperature. As an example, without limitation, the first temperature can be −40° C. to −10° C. The second temperature comprises a temperature higher than the first temperature. As another example, without limitation, the second temperature can be within a few degrees (e.g., +1, 2, or 3° C.) below or at a latent zone temperature associated with a state phase transition from solid (e.g., frozen) to liquid of the material of interest 2. If the second temperature is a latent zone temperature associated with the material of interest 2, in which change in the energy content or enthalpy of the material of interest 2 occurs but the temperature change in the material of interest 2 may be negligible or none, the second temperature may be the same or approximately the same as the first temperature even though energy is applied to the material of interest 2.

In some embodiments, RF processing system 3 may comprise a system 100 or system 1300 as described in Appendix A attached herewith. RF processing system 3 may also comprise one or more cells, zones, or stages. For example, RF processing system 3 may comprise N cells, as in the embodiment of system 1300 in Appendix A, in which each cell of the N cells may be configured to process the material of interest 2 within a particular temperature sub-range of the overall temperature range associated with the RF processing system 3. As another example, RF processing system 3 may comprise a single cell, as in the embodiment of system 100 in Appendix A, configured to cause the temperature associated with the material of interest 2 to be changed to the second temperature from the first temperature.

Processing of the material of interest 2 from the first temperature to the second temperature is also referred to as a first processing, RF dominant processing, or the like. The corresponding processing time period is referred to as the first processing time period, first time period, RF dominant processing time period, or the like.

In some embodiments, the frequency of the RF energy applied to the material of interest 2 by RF processing system 3 is controlled using voltage controlled oscillation (VCO). An oscillator module included in RF processing system 3 includes an electronic oscillator configured for dynamic operating frequency setting. A particular input voltage value applied to such an electronic oscillator determines a particular RF operating frequency of the system. As the input voltage value changes, so does the operating frequency value. Thus, the system is capable of operating at any of a variety of frequencies. While the RF frequency is held constant during processing of the material of interest 2, the frequency can change prior to or after the processing time period. Frequency can be changed/set during system configuration, at the factory to meet particular customer requirements, depending on the characteristics of the material of interest to be processed, and/or the like. As an example, without limitation, the frequency may change within 1 MHz or 3% of the previous frequency value (e.g., 27 MHz, 27.1 MHz, 12 Hz, approximately 12 Hz, 10-100 MHz, etc.).

Convection processing system 4 may be configured to continuously, periodically, sporadically, or repetitiously circulate a heated gaseous medium (with optional steam) in proximity to the material of interest 2, to cause the material of interest 2 to change from the second temperature to a third temperature higher than the second temperature and/or to cause the material of interest 2 to undergo a property/composition/chemical change and/or chemical reaction (e.g., dough proofing). A gaseous medium with optional steam (the combination also referred to as a thermal processing medium) may be heated via one or more heat sources and the heated gaseous medium may be circulated or distributed around the material of interest 2 using one or more fans or the like selectively distributed within the convection processing system 4. Convection processing system 4 may comprise one or more cells, zones, or stages, in which each cell may be associated with a particular temperature sub-range of the overall temperature range associated with system 4. For example, heat source(s) associated with a particular cell may be set to a particular temperature different from temperatures associated with heat sources of the other cells. Alternatively, one, more than one, or all cells may be configured to provide the heated gaseous medium at the same (or approximately the same) temperature as each other.

The convection processing system 4 may also include one or more steam generating mechanisms so as to provide steam or moisture and/or additional heat to the material of interest 2 during convection processing, in some embodiments. The steam may be unsaturated, saturated, or supersaturated. Transport mechanism 5 may comprise a porous structure to facilitate heated gaseous medium and/or steam circulation, in some embodiments. At least the chamber associated with the convection processing system 4, in which the material of interest 2 is to be located during convection may comprise a closed or partially enclosed space, in some embodiments. For instance, the convection processing system 4 may include inlet and/or outlet doors (not shown).

In some embodiments, convection processing system 4 may comprise any of convection systems described in Appendix B attached herewith. Moreover, certain components included in system 1 may be configured in accordance with similar components set forth in Appendix B. For instance, transport mechanism 5 need not be linear and/or horizontal as shown in FIG. 1. Instead, at least a portion of the transport mechanism 5 may be configured to be inclined, include one or more angles or turns, spiral shaped, circular, step up, step down, and/or any other two-dimensional or three-dimensional pathway shape to satisfy linear pathway length requirements and/or footprint constraints.

Processing of the material of interest 2 from the second temperature to the third temperature (or to undergo a chemical or composition change) is also referred to as a second processing, convection dominant processing, or the like. The corresponding processing time period is referred to as the second processing time period, second time period, convection dominant processing time period, or the like. In some embodiments, second and third temperatures are the same, second and third temperatures are approximately the same, third temperature is higher than the second temperature, one or both of the second and third temperatures are within a few degrees of the solid-to-liquid latent zone temperatures associated with the material of interest 2, the second temperature is a temperature near a first end of the solid-to-liquid latent zone associated with the material of interest 2 and the third temperature is a temperature near a second end, opposite the first end, of the solid-to-liquid latent zone, and/or the like.

Continuing the example of the second temperature being within a few degrees below or at a latent zone temperature associated with a state phase transition from solid (e.g., frozen) to liquid of the material of interest 2, the third temperature can be a temperature (just) above the solid-to-liquid latent zone temperature(s) associated with the material of interest 2. The second processing thus takes the material of interest 2 through its solid-to-liquid latent zone, thereby completing thawing. Alternatively, the second and third temperatures are the same or approximately the same to each other when the material of interest 2 undergoes a chemical or composition change in the second processing, for example.

In some embodiments, material of interest 2 may comprise, without limitation, one or more of the following: food; biologic material; dough; protein; meats; poultry (e.g., chicken, turkey, quail, duck); beef; pork; red meat; lamb; goat meat; rabbit; seafood; foods encased in one or more bags, plastic, film, liner, cardboard, can, packaging, enclosure, box, and/or container (collectively referred to as packaging) (e.g., raw poultry, beef, pork, or seafood products inside a vacuum sealed bag and which may, in turn, be packed in cardboard boxes); various cuts of beef (e.g., sirloin, shoulder, trimmings, chuck, brisket, round, ribs, cheek, organs, flank, skirt, bone-in cuts of beef); various cuts of pork (e.g., butt, shoulder, loin, ribs, ham, trimmings, cheek, bacon, bone-in cuts of pork); various cuts of poultry (e.g., strips, breasts, wings, legs, thighs, bone-in cuts of poultry); whole or portions of seafood (e.g., fish, salmon, tilapia, tuna, cod, halibut, haddock, octopus, shellfish (with shell on or off), crab, lobster, clams, mussels, crawfish, shrimp (shell on or off)); bone-in meat, protein, or seafood; carbohydrates; fruits; vegetables; raw or uncooked bakery goods; bakery goods; pastries; dairy; cheese; butter; cream; milks; eggs; juices; broths; liquids; soups; stews; grains; foods that are combinations of one or more of the above (e.g., pizza, lasagna, curry); non-food materials; plastics; polymers; rubbers; metals; ceramics; wood; soil; adhesives; and/or the like.

One or more materials of interest may be simultaneously processed within system 1 at a given time. As an example, a first material of interest may undergo RF processing within the RF processing system 3 while a second material of interest may simultaneously undergo convection processing within the convection processing system 4. As another example, a first plurality of materials of interest may undergo RF processing (e.g., each material of interest of the first plurality of materials of interest located at a respective cell of the plurality of RF processing cells) while a second plurality of materials of interest may simultaneously undergo convection processing within the convection processing system 4. The transport mechanism 5 associated with the RF system may be configured to operate in an incrementally advancing mode, in which the transport mechanism 5 advances/increments one cell for each time interval; thereby advancing the first plurality of materials of interest to respective next RF electrodes/antennas within a RF tunnel system, for example. This is an example of batch processing. Another example of batch processing may comprise each material of interest of the first plurality of materials of interest located at respective RF electrode/antenna locations within the RF tunnel system, and then processing all of the materials of interest to the end RF processing-related temperature without moving them within the RF tunnel system.

RF and convection processing systems 3, 4 may be configured to be separate systems from each other, according to alternative embodiments. In such a configuration, the two systems may connect to each other via the transport mechanism 5.

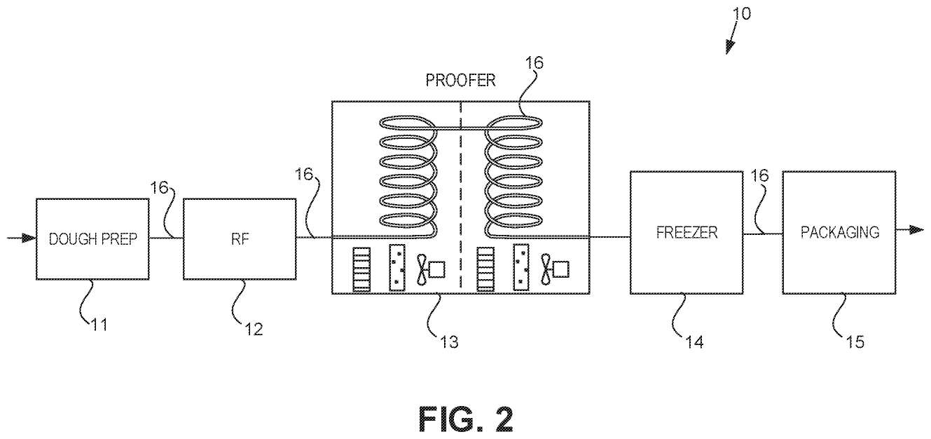

The combination processes associated with RF and convection processing systems 3, 4 may, in turn, be implemented within a larger food processing system. FIG. 2 depicts a block diagram showing an example implementation of system 1 within a multi-stage food processing system 10 in accordance with some embodiments of the present disclosure. System 10 may comprise, without limitation, a dough preparation stage 11, a RF stage 12, a dough proofer stage 13, a freezer stage 14, and a packaging stage 15.

A transport mechanism 16 may sequentially connect stages 11-15 to each other. Transport mechanism 16 may be configured to move or transport material of interest 2 from the dough preparation stage 11, to and through the RF stage 12, to and through the dough proofer stage 13, to and through the freezer stage 14, and to and through the packaging stage 15.

Material of interest 2 may comprise dough which is formed in the dough preparation stage 11 from ingredients such as, but not limited to, flour, water, yeast, starter, oil, eggs, butter, and/or the like. The dough may then be transported into the RF stage 12. In some embodiments, the RF stage 12 may comprise the RF processing system 3. To be described in detail below, RF stage 12 may be configured to increase the temperature of the dough to a temperature conducive for active proofing to take place, so that the proofing time within the dough proofer stage 13 is reduced. In some embodiments, for the dough to reach the same desired proofed state, the sum of the RF processing time (within the RF stage 12) and the dough proofing time (within the dough proofer stage 13) may be smaller than the dough proofing time (within the dough proofer stage 13) in the absence of the RF stage 12.

RF stage 12 may be configured to rapidly (at least more rapidly than by the dough proofer stage 13) “pre-heat” the dough to a temperature at which the yeast (or other proofing or activating agent within the dough) becomes active. In some embodiments, at least the surface temperature of the dough may be raised from a first temperature to a second temperature associated with active proofing. The first temperature may be in range of approximately 7 to 10 degree Celsius (° C.) and the second temperature may be in range of approximately 15 to 30° C. The second temperature may also be referred to as the proofing temperature. In some embodiments, the dough may be at the second temperature within +1° C. uniformity throughout.

The dough at the second temperature may then be provided to the dough proofer stage 13 (also referred to as the dough proofing stage) to undergo proofing. In some embodiments, dough proofer stage 13 may comprise the convection processing system 4. Dough proofer stage 13 may employ any of a variety of dough proofing configurations. As an example, dough proofer stage 13 may comprise a double spiral stack convection dough proofing equipment, in which air flow may be relatively low (e.g., flow rate in the range of approximately 2 to 20 m³/s) with relatively high humidity (e.g., relative humidity in the range of approximately 50 to 95%) and operate at a temperature in the range of approximately 18 to 38° C.

In some embodiments, the dough may rise in temperature from the second temperature to a third temperature within the dough proofer stage 13. The third temperature may be higher than the second temperature. The third temperature may be in the range of approximately 18 to 38° C.

When the dough has been proofed to the desired amount, such proofed dough may exit the dough proofer stage 13 and enter the freezer stage 14. Freezer stage 14 may be configured to rapidly decrease the dough temperature to a temperature below 0° C. (e.g., flash freeze). The frozen proofed dough may then be packaged for shipment and/or storage by the packaging stage 15. As an alternative, the proofed dough may first be packaged and then frozen.

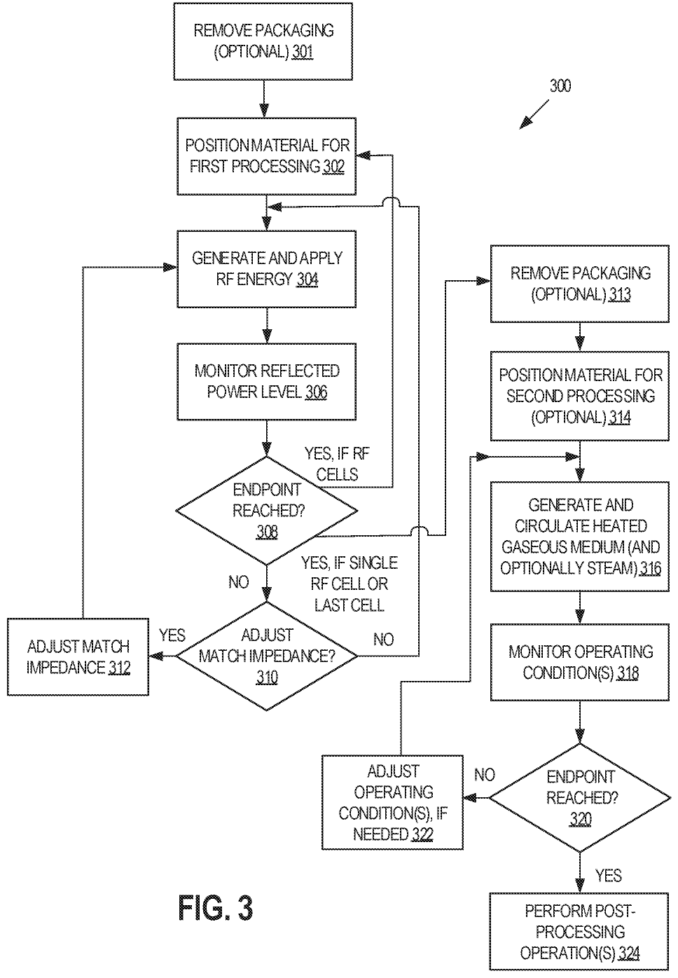

FIG. 3 depicts an example process 300 performed by system 1 to process the material of interest 2 from a start temperature (e.g., the first temperature) to an end temperature (e.g., the third temperature) in accordance with some embodiments of the present disclosure. If material of interest 2 comprises material to be processed encased in packaging (e.g., plastic, film, cardboard, bag, liner, a material having a high dielectric constant, etc.), then such packaging can be removed (or at least opened or partially removed) prior to commencement of first processing, at block 301. Alternatively, block 301 may be optional if material of interest 2 does not include packaging and/or material of interest 2 including packaging is to be processed with the packaging.

At block 302, transport mechanism 5 may be configured to position the material of interest 2 relative to the RF processing system 3 to initiate RF dominant processing (also referred to as first processing). In some embodiments, system 1 may include one or more controllers (not shown) configured to generate and communicate appropriate command signals to the transport mechanism 5 to position or align the material of interest 2 with particular electrode(s) of the RF processing system 3.

With the material of interest 2 in position, RF processing system 3 may be configured to generate and apply (continuous) RF energy or signal to the material of interest 2, at block 304. RF energy or signal is continuously applied to the material of interest 2 for the first processing time period and accordingly may also be referred to as continuous RF processing. As the RF energy or signal is applied to the material of interest 2, RF processing system 3 may be configured to monitor one or more parameters, such as the reflected power level, associated with the RF processing system 3, at block 306. Details regarding reflected power level monitoring and usage are provided in Appendix A.

Next, at block 308, a determination may be made as to whether an endpoint has been reached. The endpoint may be based on a pre-defined RF processing time, particular value of the monitored reflected power level, particular temperature of the material of interest 2, per RF processing cell, and/or the like. In embodiments in which a plurality of RF processing cells may be used to process the material of interest 2, the endpoint detection may comprise determining whether processing using the current RF processing cell has been completed and to advance the material of interest 2 to the next RF processing cell. In embodiments in which a single RF processing cell may be used to process the material of interest 2 or if the current RF processing cell comprises the last RF processing cell of the plurality of RF processing cells, the endpoint detection may comprise determining whether RF processing has been completed and to advance the material of interest 2 for convection dominant processing (e.g., second processing).

Alternatively, endpoint may be based on pre-testing of various materials of interest, in which each of the materials of interest is tested through the system to determine which settings, how long to process, etc. for each of the different system operating modes (such as the two batch processing modes discussed above) produces desired treatment of the particular material of interest. Such empirical observations/testing may be the basis for the endpoint.

If endpoint has been reached in embodiments using a plurality of RF processing cells (“yes, if RF cells” branch of block 308), then process 300 returns to block 302 to advance the material of interest 2 to the next RF processing cell. If endpoint has been reached in embodiments using a single RF processing cell or the material of interest 2 is located at the last cell of the plurality of RF processing cells (“yes, if single RF cell or last cell” branch of block 308), then process 300 may proceed to block 313. If endpoint has not been reached (no branch of block 308), then process 300 may proceed to block 310.

In some embodiments, while RF dominant processing may be in progress, an impedance matching module included in the RF processing system 3 can be adjusted in accordance with change in impedance associated with the material of interest 2 as it is changing temperature due to application of RF energy. Additional details are provided in Appendix A. If the match impedance in the impedance matching module does not need to be adjusted (no branch of block 310), then process 300 may return to block 304 to continue providing RF energy to the material of interest 2. Match impedance adjustment may be omitted if the match impedance circuitry is configured in a fixed or static configuration, the reflected power level is at or below a pre-set threshold level, endpoint is determined based on a pre-set time duration of applied continuous RF energy, system 3 is configured to operate without match impedance adjustment, and/or the like. If the match impedance is determined to be adjusted (yes branch of block 310), then process 300 may proceed to block 312 to perform the adjustment. After match impedance adjustment has been performed, process 300 may return to block 304.

As an example, if the material of interest 2 comprises dough, the applied RF energy or signal may be at approximately 10 to 100 kiloWatt (kW). The start temperature of the material of interest 2 at the beginning of RF dominant processing (e.g., the first temperature) may be approximately 7 to 10° C., and the end temperature of the material of interest 2 at the end of RF dominant processing (e.g., the second temperature) may be approximately 15 to 30° C. or a temperature at which the proofing agent included in the dough is activated for proofing to commence. The second temperature may be uniform throughout the material of interest within 1° C. The total RF dominant processing time may be less than 10 minutes, approximately 5 minutes, less than approximately 35 minutes, and/or the like.

In some embodiments, convective dominant processing may start sequentially, consecutively, and/or immediately after completion of RF dominant processing. In some embodiments, if material of interest 2 includes packaging but removal of packaging did not occur at block 301, then removal of packaging can take place a block 313. Alternatively, block 313 may be optional if material of interest 2 is already devoid of packaging (e.g., due to performance of block 301) and/or convective dominant processing is to occur with the packaging intact.

At block 314, transport mechanism 5 may be configured to position the material of interest 2 relative to the convection processing system 4 to initiate convective dominant processing. Positioning of the material of interest 2 can include moving the material of interest 2 at the second temperature into the appropriate convection processing start location within the convection processing system 4. Positioning the material of interest 2 can also or in the alternative include, without limitation, manual, automatic, and/or mechanical distribution/arrangement of the material of interest 2 comprising a plurality of sub-parts to the convection surface. For example, material of interest 2 may comprise a case of six 2.2 kilogram (kg) poultry portions (e.g., wings), and each of the six 2.2 kg poultry portions may be distributed or arranged relative to each other. System 1 may include one or more controllers (not shown) configured to generate and communicate appropriate command signals to the transport mechanism 5 to position or align the material of interest 2 at a particular location within the convection processing system 4.

Alternatively, block 314 may be optional if positioning of material of interest 2 is not required. For example, if both first and second processing occurs within the same device (e.g., RF processing system 3 includes convection components of convection processing system 4), then moving the material of interest 2 upon completion of first processing to a different device may not be required. Or if material of interest 2 is sufficiently exposed to receive heat transfer by convection, then distribution or other positioning to facilitate desired convection may not be required.

With the material of interest 2 in position, convection processing system 4 may be configured to generate and circulate a heated gaseous medium around the material of interest 2, at block 316. In some embodiments, steam may also be provided in block 316.

Continuing the above example of dough and the convection processing system 4 configured for dough proofing, the circulating heated gaseous medium may be provided at approximately 18 to 38° C., having a flow velocity in the range of approximately 0.1 to 3 m/s, and/or having a volumetric flow rate in the range of approximately 2 to 20 m³/s. In some embodiments, the maximum relative heating rate of the dough may be based on a maximum allowed surface temperature of the dough surface and the dough's heat conduction characteristics. Dough may be “held” or processed within the convection processing system 4 for approximately 65 minutes.

This is in contrast to the holding/proofing time within the same system 4 of approximately 100 minutes or more if the dough was not “pre-treated” to a proofing temperature using the RF processing system 3. Even with the RF processing time, the total time for dough proofing is less with the inclusion of the RF treatment as opposed to without RF treatment. Accordingly, higher throughput may be achieved.

In some embodiments, blocks 314 and 316 may be performed simultaneously, in which the material of interest 2 may be moving within the convection processing system 4 while surrounded by the circulating heated gaseous medium and, optionally, steam.

As convective process is in progress, one or more operating conditions associated with the convection environment may be monitored, at block 318. For example, temperature sensor(s), moisture sensor(s), gaseous velocity sensor(s), gaseous flow direction sensor(s), and/or the like may be used to determine whether the circulating heated gaseous medium and/or steam are at desired characteristics (e.g., whether the circulating heated gaseous medium is at a desired temperature).

At block 320, endpoint detection may be performed. As with block 308, the endpoint may be based on a pre-defined convection time, an end temperature detection, location of the material of interest 2 on the transport mechanism 5, and/or the like. If endpoint is detected (yes branch of block 320), then transport mechanism 5 may be actuated to position the material of interest 2 outside of the convection processing system 4 or otherwise stop convective processing of the material of interest 2, at block 324. If endpoint is not detected (no branch of block 320), then one or more of the operating conditions monitored in block 318 may be adjusted, as needed, in block 322. Then process 300 may return to block 316 to continue convective processing of material of interest 2. Additional details pertaining to convective processing are provided in Appendix B.

One or more post-convective processing operations can be performed at block 324. For instance, without limitation, the material of interest 2 (as a whole or in parts) can be packaged (e.g., pack each of the 2.2 kg poultry portions into reusable totes for local distribution to a spiral outfeed), maintain the material of interest 2 at the third temperature, transport the material of interest 2 to another processing device (e.g., fryer, flash freezer), prepare the material of interest 2 for shipment or storage, and/or the like.

In this manner, material of interest 2 may be at a first temperature at the start of the RF processing, a second temperature at the end of RF processing and start of convective processing, and a third temperature at the end of convective processing. The first and second processing times together is less than or equal to (or does not exceed) the time to process the material of interest 2 from the first to the third temperature without RF processing and with convective processing alone.

In alternative embodiments, one or both of blocks 308 and 320 may be optional where endpoint detection associated with RF or convection processes, respectively, may not be implemented.

Continuing the above example of dough proofing, dough that has been RF “pre-treated” or “pre-processed” by undergoing blocks 302-312 to 15 to 30° C. may be consecutively processed in the convection processing system 4. Once proofing starts, the proofing rate increases as the dough temperature increases and/or proofing time increases. Because the RF pre-treatment causes the dough to be at the proofing temperature when the dough enters the convection processing system 4, proofing may occur immediately (or approximately immediately) upon entering system 4 and the proofing rate of the RF pre-treated dough may be significantly higher than the proofing rate of dough that has not been RF pre-treated (e.g., non-pre-treated dough at a lower temperature such as 7 to 10° C. upon entry into system 4). With a higher proofing rate, the proofing time needed to achieve the same amount of proofing is reduced. Thus, dough may be processed for a shorter time within the convection processing system 4 while having the same (or better) proofed characteristics as dough that processed for a longer time within the convection processing system 4 with no RF pre-treatment.

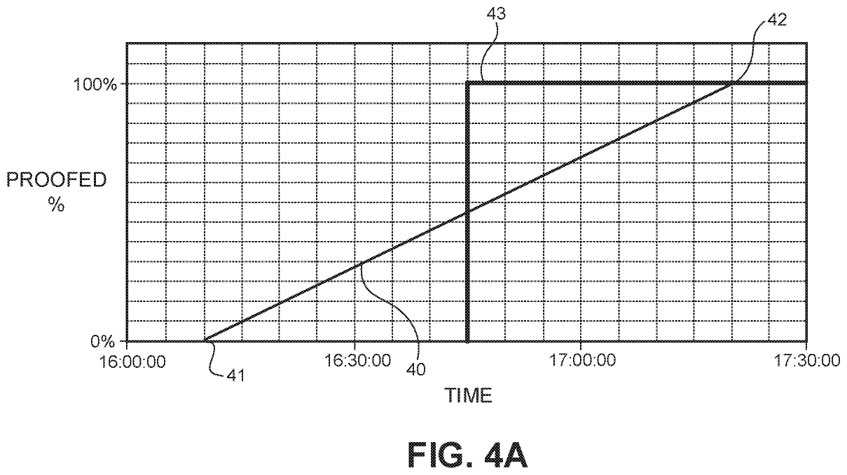

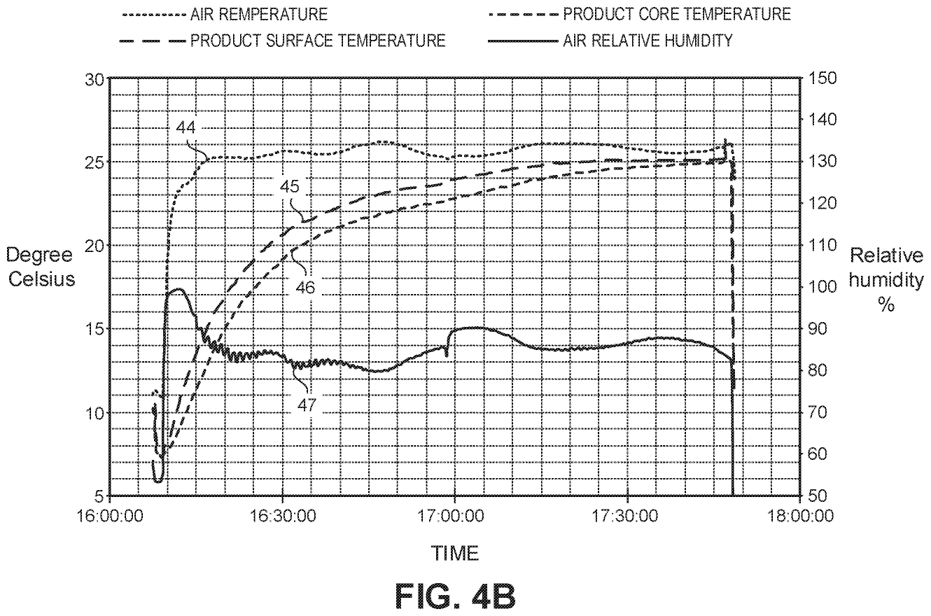

FIGS. 4A-4B depict various plot lines associated with dough proofing in accordance with some embodiments of the present disclosure. In FIG. 4A, line 40 shows the dough proofing rate (assuming proofing rate is proportional to temperature) without RF pre-treatment, from a 0% proofed at point 41 to 100% proofed at point 42. Line 40 may be associated with a processing time of approximately 100 minutes or greater in a dough proofer. Line 43 shows the dough proofing rate (assuming proofing rate is proportional to temperature) with RF pre-treatment, which is significantly higher than the proofing rate shown in line 40. Line 43 may be associated with a processing time of approximately 65 minutes in a dough proofer. In FIG. 4B, line 44 shows the temperature of air (or gaseous medium circulating within the dough proofer) as a function of time. The temperature reaches and is maintained at approximately 25-26° C. Line 45 shows the surface temperature of dough rising to approximately 25° C. Line 46 shows the core temperature of dough, which is about a degree lower than the surface temperature before rising to approximately 25° C. Line 47 shows the relative humidity of air (or gaseous medium circulating within the dough proofer) in range of 80-90%.

In alternative embodiments, the RF processing system 3 may operate at a variety of power levels. For instance, the RF energy or signals applied to the material of interest 2 may be at 6 kW. The first, second, and/or third temperatures may be different from those discussed above. The time duration of each of the RF and convection processes may be different from those discussed above. A time delay or gap may exist between end of RF processing and the start of convection processing. Convection processing system 4 may be configured to cook materials of interest, such as baking the proofed dough. Material of interest 2 may undergo pre-treatment using microwave signals provided by a microwave processing system instead of RF energy provided by the RF processing system 3.

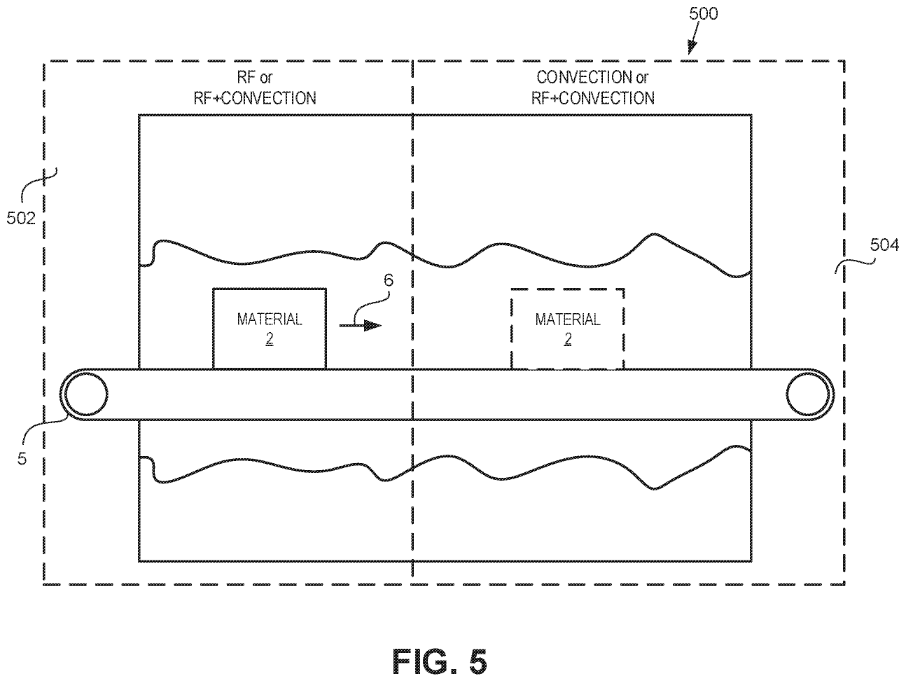

FIG. 5 depicts an example system 500 that is an alternative of system 1 in accordance with alternative embodiments of the present disclosure. System 500 includes first and second processing systems 502, 504 connected to each other via a transport mechanism 5. First processing system 502 is configured to perform the RF dominant processing (e.g., first processing) during the first processing time period. First processing system 502 comprises the RF processing system 3 or the RF processing system 3 with convective providing components (also referred to as a combined RF and convection processing system). If first processing system 502 is configured as a combined RF and convection processing system, such system includes RF and convection processing components as discussed herein for RF and convection processing systems 3, 4. The combined system is configured to provide continuous RF energy simultaneous with convection to the material of interest 2 during the first processing time period, as will be described below. The convection occurring during the first processing time period comprises a lower level/amount of convection relative to the convective processing applied during the second processing time period, and thus, the convection occurring during the first processing time period is also referred to as “light” convection, packaging-related convection, or the like.

In alternative embodiments, first processing system 502 may include air circulation components (e.g., fans) instead of convective providing components, convective providing components operated to approximate air circulation characteristics as would be generated by fans, or the like. It is understood that reference to performance of convective processing during the first processing time period encompasses any of a variety of types or intensities/levels of air (or other gaseous medium) circulatory treatment to the material of interest 2.

Second processing system 504 is configured to perform the convective dominant processing (e.g., second processing) during the second processing time period. Second processing system 504 comprises the convective processing system 4 or convective processing system 4 with RF energy generating components (also referred to as a combined RF and convection processing system). If second processing system 504 is configured as a combined RF and convection processing system, such system includes RF and convection processing components as discussed herein for RF and convection processing systems 3, 4. The combined system is configured to provide intermittent or non-continuous RF energy simultaneous with convection to the material of interest 2 during the second processing time period, as will be described below. The RF application in the second processing time period may be similar to or different from RF parameters associated with the first processing time period. The RF application during the second processing time period is also referred to as intermittent RF, non-continuous RF, or the like.

Alternatively, first and second processing systems 502, 504 together may comprise a single device or module for use during both the first and second processing time periods. The single device/module includes both RF and convection associated components configured to provide RF only, convection only, combined continuous RF and “light” convection, intermittent RF and convection, and/or the like as will be described below. The RF or convection components may be selectively powered on/off, reduced in intensity, or not used if only one of the two processes is to be performed on the material of interest 2. In other words, a device capable of both RF and convective processing is configured to operate in RF processing mode, (intense) RF and (less intense) convective processing mode, convective processing mode, or (less intense or intermittent) RF and (intense) convective processing mode at particular time periods associated with the particular first and second processing to be performed.

Accordingly, system 1 or system 500 is configured to perform one or more of the following processing schemes or techniques.

| Processing | | Second/convection |
|---|---|---|
| schemes | First/RF dominant processing | dominant processing |
| 1 | Continuous RF | Convection |
| 2 | Continuous RF + “light” | Intermittent RF + |
| | convection | convection |
| 3 | Continuous RF + “light” | Convection |
| | convection | |
| 4 | Continuous RF | Intermittent RF + |
| | | convection |

Process 300 of FIG. 3 comprises an example implementation of processing scheme 1 of the table above. Process 300 may thus also be referred to as a continuous RF and convection process. In some embodiments, packaging associated with the material of interest 2 (if it exists) is removed at block 301 in FIG. 3 for implementation of processing scheme 1.

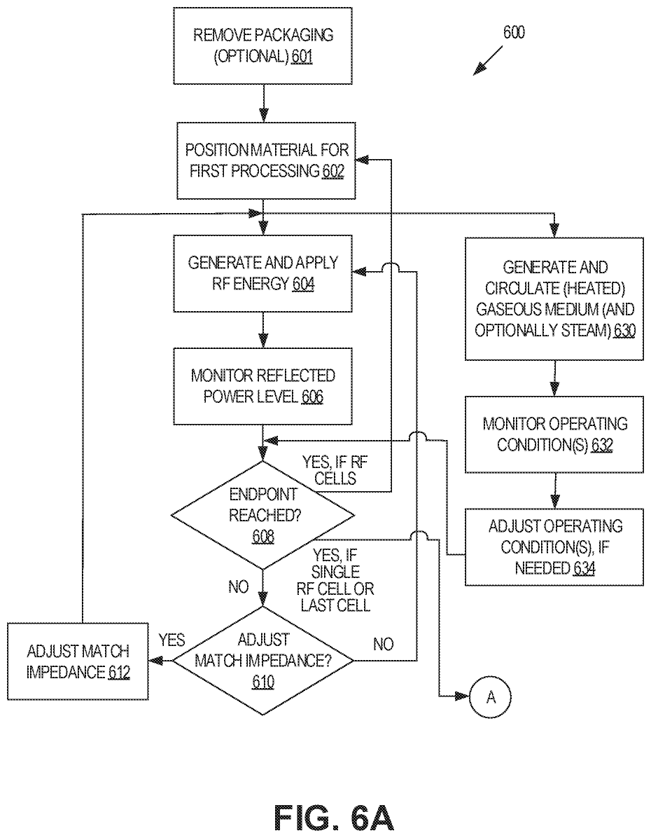

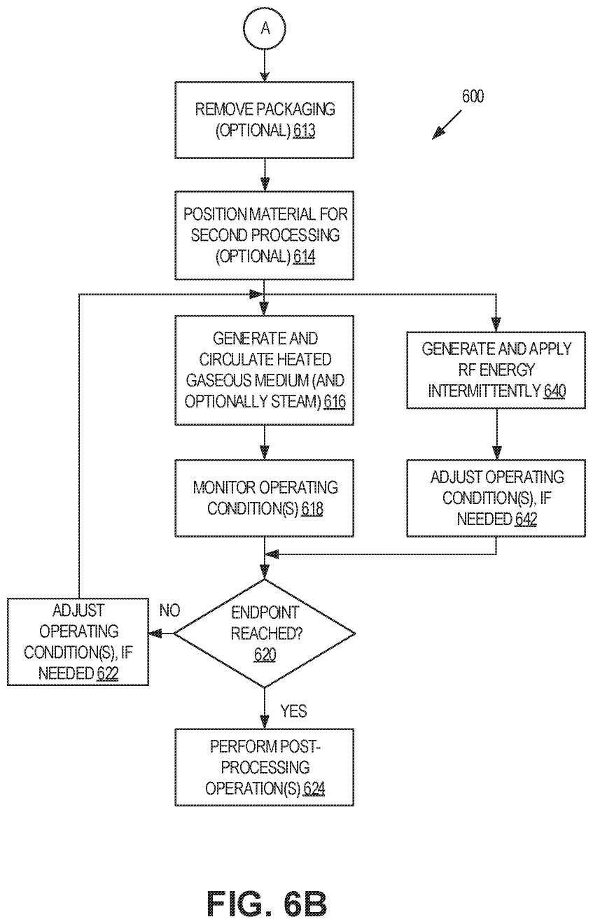

FIGS. 6A-6B depict an example process 600 performed by system 500 to process the material of interest 2 from the first temperature to the third temperature in accordance with alternative embodiments of the present disclosure. First processing system 502 of system 500 comprises a combined RF and convection system/device/module and the second processing system 504 of system 500 also comprises a combined RF and convection system/device/module. As mentioned above, first and second processing systems 502, 504 can be the same (e.g., single) system/device/module or different (e.g., two) systems/devices/modules. In embodiments where first and second processing systems 502, 504 are two systems/devices/modules, systems 502, 504 can be the same or different from each other. Process 600 comprises an example implementation of processing scheme 2—combined continuous RF and “light” convection followed by combined intermittent RF and convection.

In some embodiments, blocks 601-624 are similar to respective blocks 301-324 of FIG. 3. At least block 601 can be optional when first processing comprises processing the material of interest 2 with continuous RF energy simultaneous with convection. Block 613 may be preferred to be performed to improve temperature uniformity, to reduce the second processing time duration, and/or the like. If the first and second processing systems 502, 504 is the same single system (e.g., a single system performs both the first and second processing), then material of interest 2 at the second temperature may not need to be moved or positioned at block 614. Nevertheless, block 614 may still be performed to distribute portions of the material of interest 2 (e.g., distributing 2.2 kg of poultry portions as discussed above in connection with block 314), as appropriate.

Certain types of packaging included in the material of interest 2 have high dielectric constants. Examples of high dielectric constant packaging include, without limitation, plastic bags, film, or liners encasing or surrounding the actual material to be processed from the first temperature to the third temperature. The dielectric constant of plastic bags, film, or liners is higher or significantly higher than the dielectric constant of the actual material to be processed (e.g., food, meat, dough, etc.). Such plastic bags, film, or liners, in turn, may itself be provided inside a cardboard box or otherwise used in conjunction with a box or other container. In some cases, the high dielectric constant of the plastic bag, film, or liner is further increased in areas where the plastic bag, film, or liner is wadded or bunched, such as at the corners or at the top of the box/container. Wadding or bunching at the top of the plastic bag, film, or liner, for example, causes the top portion of the material being processed to be at a higher temperature relative to other portions of the material (e.g., local hot spot) in the presence of RF energy (e.g., when RF energy is applied at block 604). Non-uniform temperatures among different portions of the material of interest 2 are undesirable. Other non-uniformity in treatment can also be possible in the presence of packaging or other high dielectric constant materials.

Non-uniformity associated with packaging (and/or other high dielectric constant materials adjacent the material to be processed) present during RF energy application in the first processing time period, can be reduced or eliminated by providing air movement to the material of interest 2 and/or the space in which the material of interest 2 is located for the first processing time period (e.g., thaw tunnel). Air movement improves uniformity of RF processing to the material of interest 2 by reducing potential warm/hot spots within the material of interest 2 (material actually to be processed as well as surrounding packaging). Moving air past the warm/hot spots facilitates cooling those spots to a certain extent, thereby improving uniformity of the impact of RF energy application on different portions of the material of interest 2. Air movement can comprise a convective process.

Packaging referred to herein may encompass one or more structures surrounding the actual material to be RF and convectively processed such as, but not limited to, a plastic, a bag, a film, a liner, a box, a case, cardboard, a container, a fluid retaining enclosure, a high dielectric constant enclosure, an enclosure having a higher dielectric constant than the actual material to be processed, and/or the like.

Sources or conditions other than and/or in addition to packaging within the RF processing system can also contribute to undesirable treatment of the material of interest 2. In some embodiments, unintended local hot/warm spots in the material of interest 2, within the processing space (e.g., a tunnel) of the RF processing system in which the material of interest 2 is located, and/or of component(s) exposed to the processing space may be reduced, eliminated, or addressed by moving or circulating air (or other gaseous medium) to and around those areas (or through the processing space overall).

The circulating air (or other gaseous medium) may be configured to be at a particular temperature or at room/ambient temperature.

According, for the first processing time period, material of interest 2 may benefit from simultaneous application of RF and air circulation processes (e.g., convection). In some embodiments, a material of interest 2 that is void of packaging (e.g., just the product, such as meat or dough, directly processed in the first processing system 502) as well as a material of interest 2 that includes packaging (e.g., the same product, such as meat or dough, encased in packaging and processed together in the first processing system 502) may both benefit from the combination RF and convective processes performed for the first processing time period (e.g., block 601 can be performed or be optional). The combined RF and convective processes may also be referred to as simultaneous or dual RF and convective processes, continuous RF and convective processes, continuous RF and “light” convective processes, RF dominant process, RF and air circulation processes, or the like.

Returning to FIG. 6A, RF energy is continuously applied to the material of interest 2 (see blocks 604-612) during the first processing time period. Simultaneous or in conjunction with performance of blocks 604-612, blocks 630-634 associated with a convective process (or air circulation process, in general) also occurs during the first processing time period. In some embodiments, blocks 630-634 are similar to respective blocks 316, 318, and 322, except that the heated gaseous medium to be circulated in block 630 has lower convective capabilities or is deemed a lower-level convection than that of block 316 or 616. Alternatively, the heated gaseous medium may comprise non-heated (e.g., room or ambient temperature) gaseous medium (e.g., air) that is circulated to/around the material of interest 2. The temperature changing potential of the convection provided in block 630 to the material of interest 2 is negligible or significantly less than the temperature changing impact of the RF energy to the material of interest 2.

For this reason, convection occurring in the first processing time period may be referred to as “light” convection at least in comparison to convection occurring in the second processing time period, and the first processing may be overall referred to as a RF dominant processing. As an example, convection associated with block 630 may have a lower flow velocity, lower volumetric flow rate, lower temperature, not include steam, and/or the like than convection associated with block 616. Convective parameters associated with the circulating heated gaseous medium are configured to facilitate cooling of potential localized warm/hot spots of the material of interest 2 (such as due to packaging) so that the material of interest 2 uniformly changes from a first temperature to a second temperature.

In some embodiments, the second processing time period also benefits from application of both convective and RF processes to the material of interest 2, instead of just convection. One or both of material of interest 2 including packaging and material of interest 2 that does not include packaging may see improvement in treatment, uniformity, and/or processing time by simultaneous application of RF and convection in the second processing time period. If packaging has not been removed at block 601, packaging can be removed at block 613. In alternative embodiments, block 601 and/or block 613 may be optional.

As shown in FIG. 6B, during (continuous) convective processing of the material of interest 2 (see blocks 616-622) in the second processing time period, RF energy is also generated and applied to the material of interest 2 at block 640. Block 640 may be similar to block 304 except that RF energy is intermittently or non-continuously applied to the material of interest 2. One or more operating conditions or parameters associated with intermittent RF energy are adjusted, as appropriate, at block 642. As an example, the time duration of a given RF energy application, periodicity between adjacent RF energy application, RF energy power level, speed of the transport mechanism holding the material of interest 2, stop locations of the material of interest 2 within the second processing system 504, and/or the like may comprise parameters that may be adjusted to facilitate processing the material of interest 2 to the third temperature. In some embodiments, intermittent RF energy processing is configured to facilitate ice thawing while preventing overheating or product damage, especially as the material of interest 2 undergoes transition through its latent zone. Process 600 returns to block 620 after performance of block 642.

In some embodiments, RF processing associated with block 604 is at a higher intensity or level than RF processing associated with block 640. Convective processing associated with block 616 is at a higher intensity or level than convective processing associate with block 630. Alternatively, the intensity or level may be similar to each other, reversed, or otherwise configured depending on the desired second and third temperatures and/or material characteristics.

As an example, process 600 may be implemented to thaw a material of interest (e.g., chicken wings) quickly, automatically, and without loss of flavor, texture, etc. A major quick service restaurant may have cases or boxes of frozen chicken wings (at the first temperature) that are desirous of being thawed to a particular endpoint temperature above the chicken wings' solid-to-liquid latent zone. The chicken wings are first processed using RF and convection processes (e.g., blocks 604-612 and 630-634) to raise the product temperature to a second temperature that is just below its associated latent zone temperature. The RF and convection processes may occur as the chicken wings pass through a processing tunnel. Next, the chicken wings are secondly processed using convection only (e.g., blocks 316-322 of FIG. 3) or RF and convective processes (e.g., blocks 616-622 and blocks 640-642) to take the chicken wings through its latent zone, thereby completing thawing. A spiral chiller or linear chiller may be used for the second processing.

It is beneficial to configure a device or process by which a material of interest 2 can transition from solid to liquid state (also referred to as moving through the solid-to-liquid latent zone) without incurring damage, overheating, inconsistency, overly long processing time, or the like. Accordingly, for example, for a material of interest 2 to be processed through (and above) its latent zone, air is moved or circulated in a thaw tunnel (to push out stray heat from various forms of inefficiencies or undesirable impact) while RF energy is applied to change the temperature of the material of interest 2 from −18° F. to 28° F. in the first time period, then convection is applied (either alone or with RF) to move around significant amount of air for thermal processing in the second time period, to change the temperature of the material of interest 2 from 28° F. to 34° F. In both processing time periods and within both systems 502, 504, air circulation of various characteristics occurs.

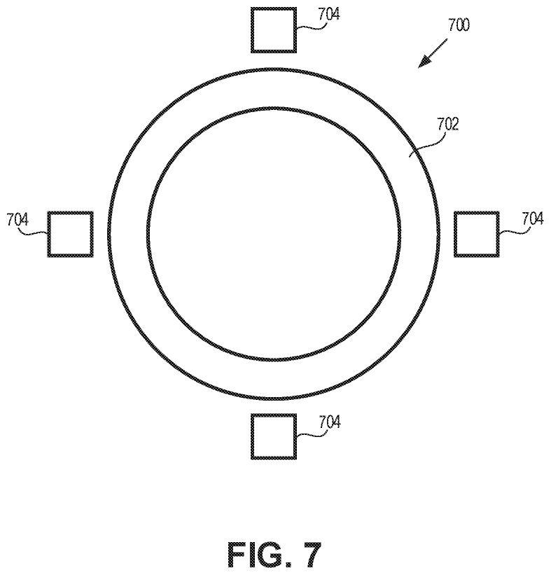

FIG. 7 depicts a top view of a portion of an example combined RF and convection system 700, device, or module in accordance with some embodiments of the present disclosure. Combined system 700 comprises a spiral chiller configured to perform at least the second processing. Combined system 800 includes a transport mechanism 702 (e.g., conveyor or track) configured in a multi-tiered spiral shape and a plurality of RF electrodes or antennas positioned at particular locations relative to the multi-tiered spiral. A plurality of RF electrodes/antennas is positioned relative to certain tiers of the plurality of tiers of the multi-tiered spiral.

For example, as shown in FIG. 7, a plurality of RF electrodes/antennas 704 (e.g., four RF electrodes/antennas) is distributed in proximity to a particular tier of the transport mechanism 702 (e.g., next to, above, etc.). Each RF electrode/antenna of the plurality of RF electrodes/antennas 704 is located in a different quadrant from each other at the 3, 6, 9, and 12 o'clock positions, for example. Each tier or each nth tier can include a set of the plurality RF electrodes/antennas. As the material of interest 2 traverses the tiers of the spiral, the material of interest 2 in sufficient proximity to respective RF electrodes/antennas is exposed to its generated RF energy. Since the material of interest 2 is not in continuous proximity to any of the RF electrodes/antennas, material of interest 2 undergoes intermittent RF application during its traversal through the spiral. The time duration of RF application by a given RF electrode/antenna can be controlled by the traversal parameters of the material of interest 2 on the transport mechanism 702 (e.g., traversal speed, continuous travel, intermittent travel, non-continuous travel, etc.).

Continuing the above example of chicken wings, cases/boxes of chicken wings may be unpacked (if not already unpacked for the first processing) and 2.2 kg smaller bags of chicken wings may be distributed on the transport mechanism 702 to move through combined system 700. System 700 can be configured to take the chicken wings through its latent zone to an end temperature just above the latent zone temperature without overheating few or portions of chicken wings. Removal of chicken wings from the case/box aids in convective heat transfer, since boxes, cases, containers, or other enclosures around the product may act as a significant (or sufficiently significant) insulator against convective heat transfer.

As another example, dual RF and convective processes can be implemented at each of the first and second processing time periods in continuous flow operations, such as at a RF and convection line implemented in a warehouse. A plurality of cases of a product to be thawed is received at the warehouse. Each case may be 33 to 80 pounds, frozen at a first temperature of approximately −18 degree Fahrenheit (F), and include packaging having a high dielectric constant. These cases traverse a RF and convection tunnel for first processing comprising simultaneous (intense) RF and (light) convective processing (e.g., blocks 604-612 and 630-634). Temperature is increased from approximately −18 degree ° F. to near the latent zone temperature associated with the product to be thawed (e.g., the second temperature).

Next, the cases are opened and a plurality of portions of the product within is distributed onto a conveyor of a device configured for second processing, such as a spiral RF and convection device (e.g., blocks 613-614). For instance, each case may include six 2.2 kg bags of poultry. Distribution may be accomplished using mechanical, manual, and/or automatic mechanisms. The 2.2 kg bags of poultry are treated with intermittent RF in conjunction with constant higher-level convection (e.g., blocks 616-622 and 640-642) to transition them through their associated latent zone. The intermittent RF aids in thawing ice while preventing overheating or product damage during the second processing time period. Lastly, the 2.2 kg bags of poultry, which are now at the third temperature just above the latent zone temperature, may be packed into reusable totes for local distribution at a spiral outfeed (e.g., block 624).

In still another example, dual RF and convective processes can be implemented at each of the first and second processing time periods in a small batch RF and convection processing unit, such as may be implemented in a quick service restaurant. A case of a product to be thawed is placed in the processing unit configured for simultaneous intense RF and light convection processing mode (e.g., the first processing). The case of the product to be thawed may be 33 to 80 pounds, frozen at a first temperature of approximately −18° F., and include packaging having a high dielectric constant. Temperature is increased from approximately −18 degree ° F. to near the latent zone temperature associated with the product to be thawed (e.g., the second temperature).

Next, the case is opened and a plurality of portions of the product within is distributed within the processing unit (e.g., the same small footprint unit as used for first processing operations). The plurality of portions of the product may include size 2.2 kg bags of poultry, for example. The plurality of portions of the product is distributed within the processing unit to facilitate convection. Distribution may be accomplished using mechanical, manual, and/or automatic mechanisms.

The 2.2 kg bags of poultry are treated with intermittent RF in conjunction with constant higher-level convection (e.g., blocks 616-622 and 640-642) to transition them through their associated latent zone. The intermittent RF aids in thawing ice while preventing overheating or product damage during the second processing time period. Lastly, the 2.2 kg bags of poultry, which are now at the third temperature just above the latent zone temperature, may be held at the third temperature (e.g., the end or target temperature) until needed. When needed, one or more of the thawed 2.2 kg bags of poultry is provided to the appropriate device for further processing, such as being moved to a restaurant fryer for deep frying.

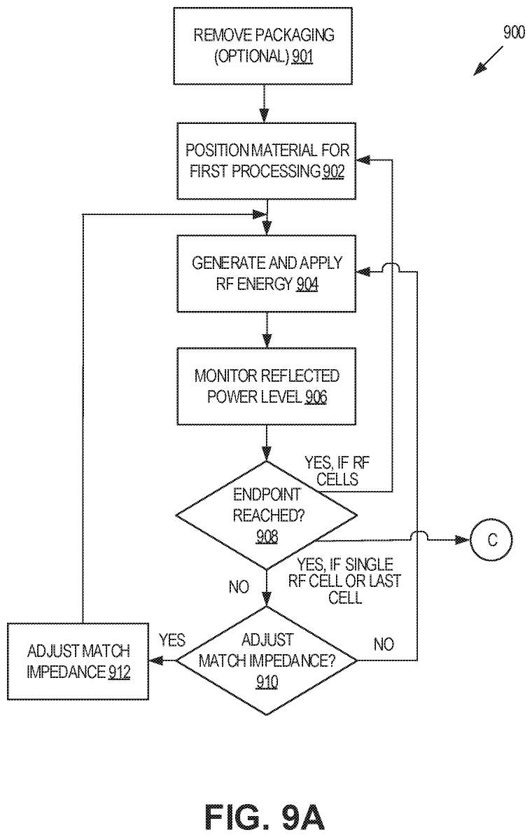

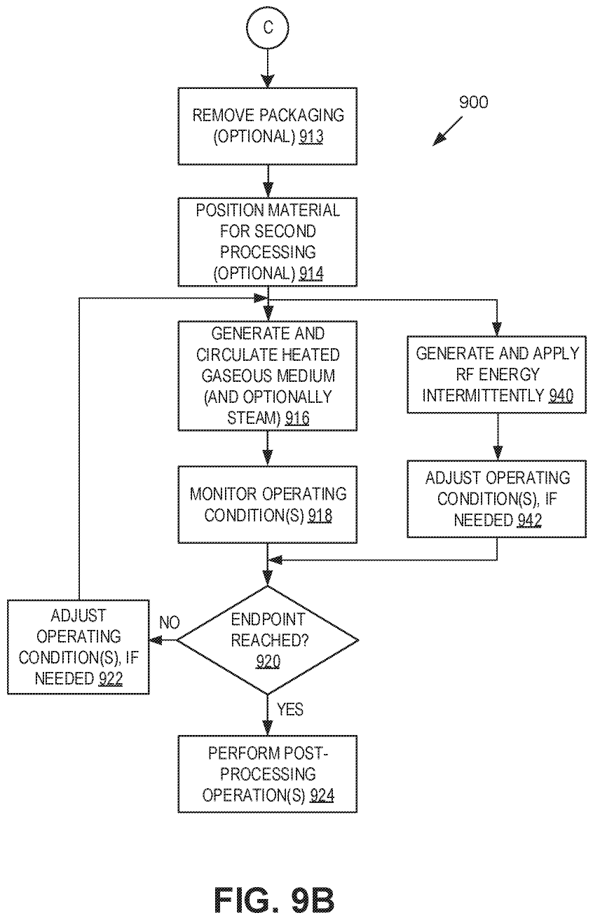

In some embodiments, if the second processing comprises operating in the intermittent RF and convective processing mode to transition the material of interest through its solid-to-liquid state transition latent zone (e.g., process 600 of FIGS. 6A-6B and process 900 of FIGS. 9A-9B), then the main source of energy for performing ice thawing of the material of interest may be handled by the intermittent RF rather than the convection. This is the case because the convection air temperature confirms to the United States Department of Agriculture (USDA) required temperature (for material of interest comprising food) but is not optimal for ice thawing.

Relying on convection alone, the temperature difference between the material of interest and the circulating air is small; as such, the amount of time required for the material of interest to change to the desired third temperature from convection alone may be too long. For example, the amount of time for the material of interest to reach the third/end temperature from the second temperature using convection alone may be 12 hours or the like. The bulk of the energy exchange during transition through the latent zone is in the latent heat of fusion. Materials of interest exhibit rapid warming and easy temperature increase within its sensible heat zone (e.g., −18° F. to −3° F.) but require a significant amount of energy to transition through its latent zone associated with solid-to-liquid phase change due to heat of fusion.

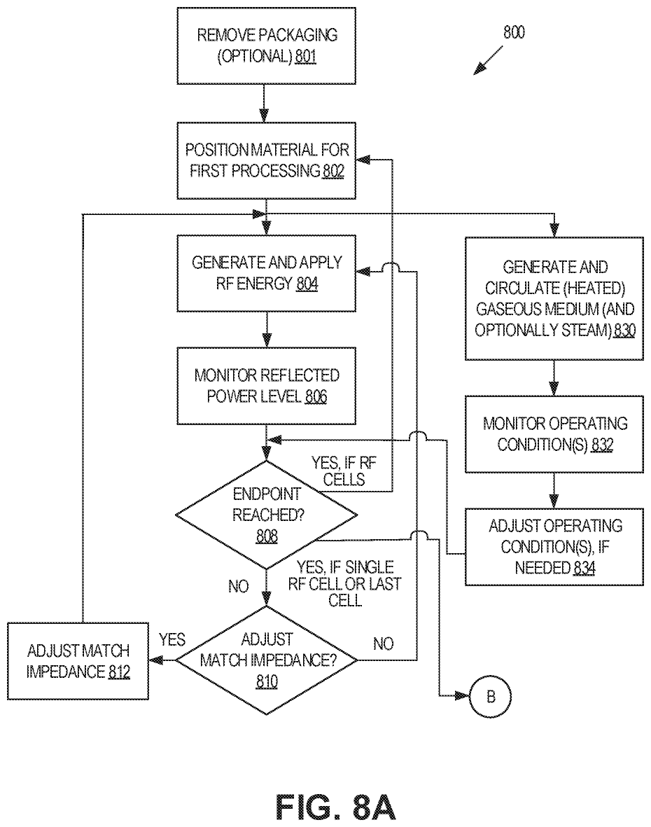

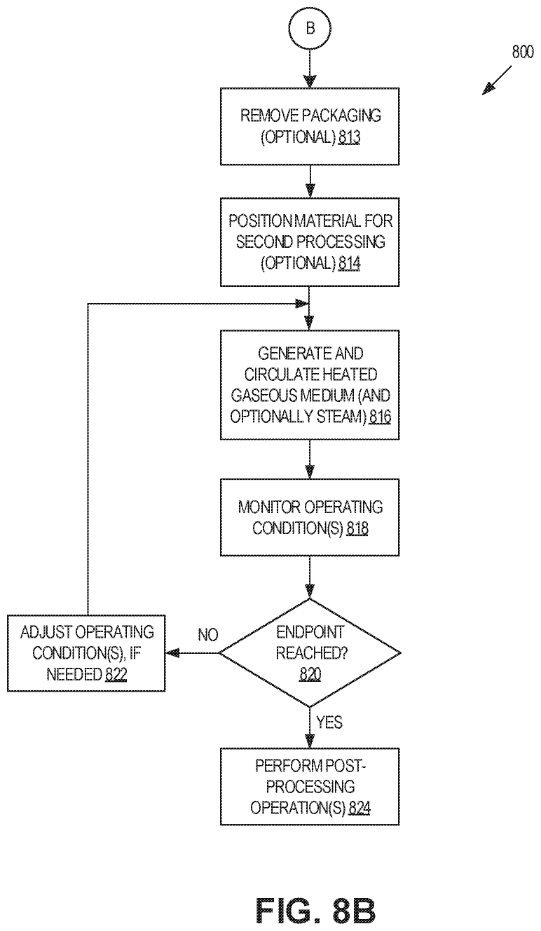

FIGS. 8A-8B depict an example process 800 performed by system 500 to process the material of interest 2 from the first temperature to the third temperature in accordance with another embodiment of the present disclosure. First processing system 502 of system 500 comprises a combined RF and convection system/device/module and the second processing system 504 of system 500 comprises a combined RF and convection system/device/module configured for convective only mode of operation (or a convection only system/device/module). As mentioned above, first and second processing systems 502, 504 can be the same (e.g., single) hardware system/device/module or different (e.g., two) systems/devices/modules. In embodiments where first and second processing systems 502, 504 are two systems/devices/modules, systems 502, 504 can be the same or different from each other. Process 800 comprises an example implementation of processing scheme 3—combined continuous RF and “light” convection followed by convection.

In some embodiments, blocks 801-824 and 830-834 are similar to respective blocks 601-624 and 630-634 of FIGS. 6A-6B. Since lower intensity convection (or air circulation) is applied at blocks 830-834 simultaneous with continuous RF energy application at blocks 804-812, even if the material of interest 2 includes packaging, block 801 may be optional and first processing may occur with the packaging intact. In some embodiments, material of interest 2 may be processed during the first processing time period with the packaging and then block 813 may be performed to remove the packaging to better expose the product for the higher intensity convective heat transfer to occur in the second processing time period. Alternatively, block 801 may be omitted and blocks 804-812 and 830-834 may be performed on material of interest 2 that does not include packaging. In which case, block 813 may also be omitted.

If the material of interest 2 will not be transitioning through its latent zone as it is processed from the start temperature to the desired end temperature, then process 800 or 300 may be appropriate for processing such material of interest 2. For example, without limitation, if second processing of the material of interest 2 comprises dough proofing as described in connection with FIG. 2, then intermittent RF processing may not be required during the second processing period.

FIGS. 9A-9B depict an example process 900 performed by system 500 to process the material of interest 2 from the first temperature to the third temperature in accordance with still another embodiment of the present disclosure. First processing system 502 of system 500 comprises a combined RF and convection system/device/module configured for RF only mode of operation (or a RF only system/device/module), and the second processing system 504 of system 500 comprises a combined RF and convection system/device/module. As mentioned above, first and second processing systems 502, 504 can be the same (e.g., single) hardware system/device/module or different (e.g., two) systems/devices/modules. In embodiments where first and second processing systems 502, 504 are two systems/devices/modules, systems 502, 504 can be the same or different from each other. Process 900 comprises an example implementation of processing scheme 4—RF followed by combined intermittent RF and convection.

In some embodiments, blocks 901-924 and 940-942 are similar to respective blocks 601-624 and 640-642 of FIGS. 6A-6B. If material of interest 2 includes packaging, such packaging can be removed at block 901. In which case, block 913 may be omitted. In alternative embodiments block 901 may be omitted and the packaging be removed at a later processing point (e.g., at block 913) or not at all.

As an example, without limitation, material of interest 2 with no packaging (e.g., removed at block 901) or having packaging at a lower dielectric constant (at least low enough not to incur hot/warm spots associated with undesirable temperature non-uniformity) may not require air movement (e.g., convection) during RF application in the first processing time period. Hence, RF only processing of blocks 904-912 may be sufficient to achieve the desired second temperature and without adverse impact on the material of interest 2. Then if it is desirous for such material of interest 2 to transition through its latent zone to reach the third/end temperature, then the RF and convection combined processes of the rest of process 900 can be performed.

It is understood that RF energy applied for second processing may alternatively be continuous, of similar intensity as the RF energy applied for the first processing, of higher intensity than the RF energy applied for the first processing, and/or the like for processes 600 and/or 900. It is also understood that air movement provided in the first processing in processes 600 and/or 800 is not limited to convection and may be achieved by a variety of other air circulation mechanisms, such as using impingement units or the like.

Illustrative examples of the apparatuses, systems, and methods of various embodiments disclosed herein are provided below. An embodiment of the apparatus or system may include any one or more, and any combination of, the examples described below.

1. A method comprising:

positioning a load at a first temperature to electrically couple with a radio frequency (RF) processing system;

applying, for a first time period, a RF signal to the load to change a temperature of the load from a first temperature to a second temperature;

positioning the load at the second temperature within a convection processing system; and

circulating, for a second time period, a heated gaseous medium around the load to change the temperature of the load from the second temperature to a third temperature or to cause the load to undergo a chemical reaction,

wherein the first and second time periods together is less than or equal to a time period for the load to change from the first temperature to the third temperature or from the first temperature to undergo the chemical reaction from convective processing and absent application of the RF signal.

2. The method of clause 1, further comprising:

determining whether an endpoint with respect to RF processing is detected; and

if the determination is affirmative, positioning the load within the convection processing system.

3. The method of any of clauses 1-2, wherein determining whether the endpoint is detected comprises determining whether the endpoint is detected based on a reflected power level.

4. The method of any of clauses 1-3, wherein determining whether the endpoint is detect comprises determining whether the RF signal has been applied to the load for a particular amount of time.

5. The method of any of clauses 1-4, wherein circulating the heated gaseous medium around the load comprises transitioning the load through a solid-to-liquid phase transition latent zone associated with the load.

6. The method of any of clauses 1-5, further comprising circulating steam around the load simultaneous with circulating the heated gaseous medium around the load.

7. The method of any of clauses 1-6, wherein the steam comprises unsaturated, saturated, or super saturated steam.

8. The method of any of clauses 1-7, wherein the convection processing system comprises a dough proofing system, and wherein circulating the heated gaseous medium around the load comprises circulating the heated gaseous medium to proof the load.

9. The method of any of clauses 1-8, wherein the second temperature is higher than the first temperature and the third temperature is higher than the second temperature.

10. The method of any of clauses 1-9, wherein the first temperature is approximately 7 to 10 degree Celsius (° C.), and the second temperature is approximately 15 to 30° C. or a temperature at which a proofing agent included in the load is activated.

11. The method of any of clauses 1-10, wherein circulating the heated gaseous medium around the load comprises circulating the heated gaseous medium around the load for a duration of approximately 65 minutes.

12. The method of any of clauses 1-11, wherein applying the RF signal to the load comprises applying the RF signal to the load consecutively to circulating the heated gaseous medium to the load.

13. The method of any of clauses 1-12, wherein circulating the heated gaseous medium around the load comprises circulating the heated gaseous medium to the load after a time delay after the load is at the second temperature.

14. The method of any of clauses 1-13, wherein the load comprises food or dough.

15. The method of any of clauses 1-14, wherein applying the RF signal to the load comprises changing an energy content of the load, and wherein the first and second temperatures are the same.

16. The method of any of clauses 1-15, wherein positioning the load at the first temperature comprises continuously moving the load through the RF processing system and positioning the load at the second temperature comprises continuously moving the load through the convection processing system.

17. The method of any of clauses 1-16, wherein the second temperature is within a few degrees below or a temperature of a latent zone associated with the load, one or both of the second and third temperatures are within a few degrees of the latent zone associated with the load, or the second temperature is a temperature near a first end of the latent zone associated with the load and the third temperature is a temperature near a second end, opposite the first end, of the latent zone associated with the load.

18. A system comprising:

a first unit configured to generate and apply radio frequency (RF) energy to a load positioned in the first unit during a first time period, wherein the load is at a first temperature at a start of the first time period and at a second temperature different from the first temperature at an end of the first time period; and

a second unit configured to receive the load at the second temperature and to cause heat transfer by convection to the load during a second time period different from the first time period, wherein the load is at a third temperature at an end of the second time period,

wherein the first and second time periods together is less than or equal to a time period for the load to change from the first temperature to the third temperature from convective processing and without application of the RF energy.

19. The system of clause 18, wherein the second temperature is higher than the first temperature, the third temperature is higher than the second temperature, the second and third temperatures are the same, the second and third temperatures are approximately the same, one or both of the second or third temperatures is at or near a temperature of a solid-to-liquid phase transition latent zone associated with the load, or the second temperature is a temperature near a first end of the solid-to-liquid phase transition latent zone and the third temperature is a temperature near a second end, opposite the first end, of the solid-to-liquid phase transition latent zone.

20. The system of any of clauses 18-19, wherein the second unit is configured to transition the material through a solid-to-liquid phase transition latent zone associated with the load.

21. The system of any of clauses 18-20, wherein the first unit is further configured to generate and provide air circulation to the load during the first time period.

22. The system of any of clauses 18-21, wherein the air circulation comprises convection.

23. The system of any of clauses 18-22, wherein the second unit is further configured to generate and apply a second RF energy different from the RF energy to the load during the second time period.

24. A system comprising:

a first device that includes first radio frequency (RF) signal generation components and first gaseous medium circulation generation components, the first device configured to simultaneously provide first RF processing and first gaseous medium circulatory processing to a material of interest for a first time period; and

a second device that includes second convection generation components, the second device configured to provide second convective processing to the material of interest for a second time period after the first time period,

wherein the material of interest changes from a first temperature to a second temperature during the first time period and from the second temperature to a third temperature during the second time period.

25. The system of clause 24, wherein the first gaseous medium circulatory processing is of a lower intensity or level than the second convective processing, the first gaseous medium circulatory processing comprises convective processing, or the first gaseous medium circulatory processing comprises air circulation.

26. The system of any of clauses 24-25, wherein the second device further includes second RF signal generation components, the second device further configured to simultaneously provide second RF processing and the second convective processing to the material of interest for the second time period.

27. The system of any of clauses 24-26, wherein the second RF processing comprises intermittent RF processing.

28. The system of any of clauses 24-27, wherein the second RF processing is of a lower intensity or level than the first RF processing.

29. The system of any of clauses 24-28, wherein the first and second devices are the same device.

30. The system of any of clauses 24-29, wherein the first and second devices are different devices and the material of interest is moved from the first device to the second device to receive the simultaneous second RF processing and the second convective processing.

31. The system of any of clauses 24-30, wherein the second temperature is higher than the first temperature, the third temperature is higher than the second temperature, the second and third temperatures are the same, the second and third temperatures are approximately the same, one or both of the second or third temperatures is at or near a temperature of a solid-to-liquid phase transition latent zone associated with the material of interest, or the second temperature is a temperature near a first end of the solid-to-liquid phase transition latent zone and the third temperature is a temperature near a second end, opposite the first end, of the solid-to-liquid phase transition latent zone.

32. The system of any of clauses 24-31, wherein the material of interest comprises a material, to be changed from the first temperature to the third temperature, and packaging surrounding the material, and wherein the packaging surrounding the material comprises one or more of a plastic, a bag, a film, a liner, a box, a case, cardboard, a container, a fluid retaining enclosure, or a high dielectric constant enclosure.

33. A system comprising:

a first device that includes first radio frequency (RF) signal generation components, the first device configured to provide first RF processing to a material of interest for a first time period; and

a second device that includes second RF generation components and second convection generation components, the second device configured to simultaneously provide second RF processing and second convective processing to the material of interest for a second time period after the first time period,

wherein the material of interest changes from a first temperature to a second temperature during the first time period and from the second temperature to a third temperature during the second time period.

34. The system of clause 33, wherein the second RF processing is of a lower intensity or level than the first RF processing.

35. The system of any of clauses 33-34, wherein the second RF processing comprises intermittent RF processing.

36. The system of any of clauses 33-35, wherein the first device further includes first gaseous medium circulatory processing, the first device further configured to simultaneously provide first gaseous medium circulatory processing and the first RF processing to the material of interest for the first time period.

37. The system of any of clauses 33-36, wherein the first and second devices are the same device.

38. The system of any of clauses 33-37, wherein the first and second devices are different devices and the material of interest is moved from the first device to the second device to receive the simultaneous second RF processing and the second convective processing.

39. The system of any of clauses 33-38, wherein the first gaseous medium circulatory processing is of a lower intensity or level than the second convective processing, the first gaseous medium circulatory processing comprises convective processing, or the first gaseous medium circulatory processing comprises air circulation.

40. The system of any of clauses 33-39, wherein the second device is configured to transition the material of interest through a solid-to-liquid phase transition latent zone associated with the material of interest.

41. The system of any of clauses 33-40, wherein the second temperature is higher than the first temperature, the third temperature is higher than the second temperature, the second and third temperatures are the same, the second and third temperatures are approximately the same, one or both of the second or third temperatures is at or near a temperature of a solid-to-liquid phase transition latent zone associated with the material of interest, or the second temperature is a temperature near a first end of the solid-to-liquid phase transition latent zone and the third temperature is a temperature near a second end, opposite the first end, of the solid-to-liquid phase transition latent zone.

42. The system of any of clauses 33-41, wherein the material of interest comprises a material, to be changed from the first temperature to the third temperature, and packaging surrounding the material, and wherein the packaging has a higher dielectric constant than the material.

43. A system comprising:

a first unit configured to generate and apply radio frequency (RF) energy and air circulation to a load positioned in the first unit during a first time period, wherein the load is at a first temperature at a start of the first time period and at a second temperature different from the first temperature at an end of the first time period; and

a second unit configured to receive the load at the second temperature and to cause heat transfer by convection to the load during a second time period different from the first time period, wherein the load is at a third temperature different from the second temperature at an end of the second time period,

wherein at least one of the second or third temperatures is at or near a temperature of a solid-to-liquid phase transition latent zone associated with the load.

44. The system of clause 43, wherein the second unit is configured to transition the material through the solid-to-liquid phase transition latent zone associated with the material.

45. The system of any of clauses 43-44, wherein the air circulation comprises convection.

The above description of illustrated embodiments of the claimed subject matter, including what is described in the Abstract, is not intended to be exhaustive or to limit the claimed subject matter to the precise forms disclosed. While specific embodiments of, and examples for, the claimed subject matter are described herein for illustrative purposes, various modifications are possible within the scope of the claimed subject matter, as those skilled in the relevant art will recognize.

These modifications can be made to the claimed subject matter in light of the above detailed description. The terms used in the following claims should not be construed to limit the claimed subject matter to the specific embodiments disclosed in the specification. Rather, the scope of the claimed subject matter is to be determined entirely by the following claims, which are to be construed in accordance with established doctrines of claim interpretation.

### APPENDIX A

1. A method comprising:
positioning a load at a first temperature to electrically couple with a radio frequency (RF) processing system;
applying, for a first time period, an RF signal to the load to change a temperature of the load from a first temperature to a second temperature;
positioning the load at the second temperature within a convection processing system; and
circulating, for a second time period, a heated gaseous medium around the load to change the temperature of the load from the second temperature to a third temperature or to cause the load to undergo a chemical reaction,
wherein a convective heat energy applied during the second time period is less than an RF energy applied during the first time period.

2. The method of claim 1, further comprising:
determining whether an endpoint with respect to RF processing is detected, wherein determining whether the endpoint is detected comprises determining whether the endpoint is detected based on a reflected power level.

3-4. (canceled)

5. The method of claim 1, wherein circulating the heated gaseous medium around the load comprises transitioning the load through a solid-to-liquid phase transition latent zone associated with the load.

6. The method of claim 1, further comprising circulating steam around the load simultaneous with circulating the heated gaseous medium around the load.

7. (canceled)

8. The method of claim 1, wherein the convection processing system comprises a dough proofing system, and wherein circulating the heated gaseous medium around the load comprises circulating the heated gaseous medium to proof the load.

9. (canceled)

10. The method of claim 1, wherein the first temperature is approximately 7 to 10 degree Celsius (° C.), and the second temperature is approximately 15 to 30° C. or a temperature at which a proofing agent included in the load is activated.

11. The method of claim 1, wherein circulating the heated gaseous medium around the load comprises circulating the heated gaseous medium around the load for a duration of approximately 65 minutes.

12. The method of claim 1, wherein applying the RF signal to the load comprises applying the RF signal to the load is prior to circulating the heated gaseous medium to the load.

13. The method of claim 1, wherein circulating the heated gaseous medium around the load comprises circulating the heated gaseous medium to the load after a time delay after the load is at the second temperature.

14. (canceled)

15. The method of claim 1, wherein applying the RF signal to the load comprises changing an energy content of the load, and wherein the first and second temperatures are the same.

16. The method of claim 1, wherein positioning the load at the first temperature comprises continuously moving the load through the RF processing system and positioning the load at the second temperature comprises continuously moving the load through the convection processing system.

17. (canceled)

18. A system comprising:
a first unit configured to generate and apply radio frequency (RF) energy to a load positioned in the first unit during a first time period, wherein the load is at a first temperature at a start of the first time period and at a second temperature different from the first temperature at an end of the first time period; and
a second unit configured to receive the load at the second temperature and to cause heat transfer by convection to the load during a second time period different from the first time period, wherein the load is at a third temperature at an end of the second time period, wherein a convective heat energy applied during the second time period is less than the RF energy applied during the first time period.

19. The system of claim 18, wherein the second temperature is higher than the first temperature, the third temperature is higher than the second temperature, and the second and third temperatures are the same, wherein the second or third temperatures are at a temperature of a solid-to-liquid phase transition latent zone associated with the load.

20. The system of claim 18, wherein the second unit is configured to transition the material through a solid-to-liquid phase transition latent zone associated with the load.

21. The system of claim 18, wherein the first unit is further configured to generate and provide air circulation to the load during the first time period.

22. (canceled)

23. The system of claim 18, wherein the second unit is further configured to generate and apply a second RF energy different from the RF energy to the load during the second time period.

24-32. (canceled)

33. A system comprising:
a first device that includes first radio frequency (RF) signal generation components, the first device configured to provide first RF processing to a material of interest for a first time period; and
a second device that includes second RF generation components and second convection generation components, the second device configured to simultaneously provide second RF processing and second convective processing to the material of interest for a second time period after the first time period,
wherein the material of interest changes from a first temperature to a second temperature during the first time period and from the second temperature to a third temperature during the second time period.

34. The system of claim 33, wherein the second RF processing is of a lower intensity or level than the first RF processing.

35. The system of claim 33, wherein the second RF processing comprises intermittent RF processing.

36. The system of claim 33, wherein the first device further includes first gaseous medium circulatory processing, the first device further configured to simultaneously provide first gaseous medium circulatory processing and the first RF processing to the material of interest for the first time period.

37. (canceled)

38. The system of claim 36, wherein the first and second devices are different devices and the material of interest is moved from the first device to the second device to receive the second RF processing and the second convective processing simultaneously.

39. The system of claim 36, wherein the first gaseous medium circulatory processing is of a lower intensity or level than the second convective processing, the first gaseous medium circulatory processing comprises convective processing, or the first gaseous medium circulatory processing comprises air circulation.

40. The system of claim 33, wherein the second device is configured to transition the material of interest through a solid-to-liquid phase transition latent zone associated with the material of interest.

41. The system of claim 33, wherein the second temperature is higher than the first temperature, the second and third temperatures are the same, the second or third temperatures is at or near a temperature of a solid-to-liquid phase transition latent zone associated with the material of interest.

42. The system of claim 33, wherein the material of interest comprises a material, to be changed from the first temperature to the third temperature, and packaging surrounding the material, and wherein the packaging has a higher dielectric constant than the material.

43-45. (canceled)

46. A method comprising:
positioning a load at a first temperature to electrically couple with a radio frequency (RF) processing system;
applying, for a first time period, an RF signal to the load to change a temperature of the load from a first temperature to a second temperature;
positioning the load at the second temperature within a convection processing system; and
circulating, for a second time period, a heated gaseous medium around the load to change the temperature of the load from the second temperature to a third temperature or to cause the load to undergo a chemical reaction,
wherein a convective heat energy applied during the second time period is higher than an RF energy applied during the first time period.

47. The method of claim 46, further comprising:
determining whether an endpoint with respect to RF processing is detected, wherein determining whether the endpoint is detected comprises determining whether the endpoint is detected based on a reflected power level.
